(19) United States
(12) Patent Application Publication
(10) Pub. No.: US 2026/0170020 A1
(43) Pub. Date: Jun. 18, 2026

(54) APPARATUS AND METHOD WITH EMBEDDING-BASED DOCUMENT INDEX GENERATION

(71) Applicant: Samsung Electronics Co., Ltd., Suwon-si (KR)

(72) Inventors: Sunjun HWANG, Suwon-si (KR); Seongeun KIM, Suwon-si (KR); Seungin PARK, Suwon-si (KR); Ilwi YUN, Suwon-si (KR); Dongwook LEE, Suwon-si (KR)

(73) Assignee: Samsung Electronics Co., Ltd., Suwon-si (KR)

(21) Appl. No.: 19/197,114

(22) Filed: May 2, 2025

(30) Foreign Application Priority Data
Dec. 16, 2024 (KR) 10-2024-0187487

(51) Int. Cl. G06F 16/31; G06F 16/334

(52) U.S. Cl. CPC G06F 16/31; G06F 16/3347

(57) ABSTRACT

An operating method of an electronic apparatus includes: detecting layout regions in a document file; generating embedding vectors of the respective detected layout regions by performing embedding operations on the respective detected layout regions; forming a combination of embedding vectors selected from among the generated embedding vectors; determining, based on the combination of the selected embedding vectors, a first index indexing the layout regions respectively corresponding to the selected embedding vectors; accessing the first index based on a received user request; and generating a response to the received user request using a generative model and the accessed first index.

### CROSS-REFERENCE TO RELATED APPLICATIONS

This application claims the benefit under 35 USC § 119(a) of Korean Patent Application No. 10-2024-0187487, filed on Dec. 16, 2024, in the Korean Intellectual Property Office, the entire disclosure of which is incorporated by reference herein for all purposes.

### BACKGROUND

### 1. Field

The following description relates to an electronic apparatus and method with document index generation.

### 2. Description of Related Art

Existing document indexing methods that perform chunking by character count or sentence unit may be applied to structured document files (e.g., document files that include only text content). Sentences in unstructured document files (e.g., document files including images, graphs, etc.) are not arranged in a consistent manner, so it can be difficult to apply existing document indexing methods to unstructured document files.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operating method of an electronic apparatus includes: detecting layout regions in a document file; generating embedding vectors of the respective detected layout regions by performing embedding operations on the respective detected layout regions; forming a combination of embedding vectors selected from among the generated embedding vectors; determining, based on the combination of the selected embedding vectors, a first index indexing the layout regions respectively corresponding to the selected embedding vectors; accessing the first index to perform retrieval based on a received user request; and generating a response to the received user request using a generative model and the accessed first index.

The combination of the selected embedding vectors may include a vector generated by concatenating the selected embedding vectors.

The method may further include: receiving the user request from a user terminal; in response to obtaining, from a database (DB), the first index related to the received user request, determining whether a user has permission for the first index; in response to determining that the user has the permission, generating the response using the first index and the generative model; and transmitting the generated response to the user terminal.

The method may further include: receiving the user request from a user terminal; in response to obtaining, from a database (DB), the first index related to the received user request, determining whether a user has permission for the first index; in response to determining that the user does not have the permission, transmitting, to the user terminal, a message indicating failure to provide the response to the user request.

The method may further include: based on content in the document file being changed, identifying a layout region, among the detected layout regions, encompassing the changed information; generating a first embedding vector of the identified layout region, the first embedding vector reflecting the changed content; based on the first index including a second embedding vector of a layout region encompassing the content before being changed, forming a combination of an embedding vector in the first index other than the second embedding vector and the generated first embedding vector; and determining, based on the combination of the generated first embedding vector with the other embedding vector in the first index, a second index for the identified layout region and a layout region of the embedding vector in the first index.

The method may further include: replacing the first index with the determined second index in a database (DB).

The method may further include: setting a user or a group with access to the first index.

In another general aspect, an operating method of an electronic apparatus includes: generating embedding vectors respectively corresponding to each of layout regions of a document file by performing embedding operations on the respective layout regions; generating vector sets from the generated embedding vectors, wherein each of the vector sets includes at least one of the generated embedding vectors; forming combinations of embedding vectors from the respective generated vector sets; determining indices for the document file from the respective combinations; storing the indices in a database (DB); accessing, from the DB, based on a received user request, a first index among the indices stored in the DB; and generating a response to the received user request using a generative model and the accessed first index.

Each index may be a concatenation of the embedding vectors in its corresponding vector set.

The method may further include: receiving the user request from a user terminal; in response to accessing, from the DB, the first index related to the received user request, determining whether a user has permission for the first index; in response to determining that the user has the permission, generating the response using the first index and the generative model; and transmitting the generated response to the user terminal.

The method may further include: receiving the user request from a user terminal; in response to accessing, from the DB, the first index related to the received user request, determining whether a user has permission for the first index; in response to determining that the user does not have the permission, transmitting, to the user terminal, a message indicating failure to provide a response to the user request.

The method may further include: in response to information in the document file being changed, identifying a layout region encompassing the changed information; generating a first embedding vector from the changed information in the identified layout region; identifying, among the indices, an index corresponding to the identified layout region, the index of the identified layout region including one of the generated embedding vectors; generating a replacement index including a combination of the one of the generated embedding vectors and the generated first embedding vector; and in the DB, replacing the identified index with the generated first index.

The method may further include: setting a user or a group with access to each of the determined plurality of indices.

In yet another general aspect, an electronic apparatus includes: one or more processors; and memory storing instructions configured to cause the one or more processors to: detect layout regions in a document file; based on the detected layout regions, generate embedding vectors of the respective detected layout regions by performing embedding on portions of content in the respective detected layout regions; form a combination of at least some of the embedding vectors; generate a first index indexing those of the layout regions that respectively correspond to the at least some of the embedding vectors; access the first index based on a received user request; and generate a response to the received user request using a generative model and the accessed first index.

The first index may include the combination, which is a concatenation of the at least some of the embedding vectors.

The instructions may be further configured to cause the one or more processors to: receive the user request from a user terminal; in accessing the first index from a database (DB) to service the received user request, determine whether a user has permission specific to the first index; in response to determining that the user has the permission specific to the first index, generate the response using the first index and the generative model; and transmit the generated response to the user terminal.

The instructions may be further configured to cause the one or more processors to: receive the user request from a user terminal; in accessing the first index from a database (DB) to service the received user request, determine whether a user has permission specific to the first index; and in response to determining that the user does not have the permission specific to the first index, transmit, to the user terminal, a message indicating failure to provide the response to the user request.

The instructions may be further configured to cause the one or more processors to: identify a content change within a layout region among the layout regions; generate a first embedding vector for the changed layout region, the first embedding vector reflecting the content change; determine that the first index corresponds to the layout region identified as having changed; select a second embedding vector of the identified first index, the second embedding vector not corresponding to a layout region other than the changed layout region; and form a second index from a combination of the first embedding vector and the second embedding vector.

The instructions may be further configured to cause the one or more processors to replace the first index with the second index in a database (DB).

The instructions may be further configured to cause the one or more processors to set a user or a group with access to the first index.

Other features and aspects will be apparent from the following detailed description, the drawings, and the claims.

### BRIEF DESCRIPTION OF THE DRAWINGS

FIG. 1 illustrates an example of an operation of an electronic apparatus for generating an index from a document file, according to one or more embodiments.

FIG. 2 illustrates an example of chunking and embedding of an electronic apparatus, according to one or more embodiments.

FIG. 3 illustrates an example of a combination of embedding vectors of an electronic apparatus, according to one or more embodiments.

FIG. 4 illustrates an example of an operation in which an electronic apparatus sets permission for each generated index, according to one or more embodiments.

FIGS. 5A, 5B, and 5C illustrate examples of an operation in which an electronic apparatus generates an index when information in a document file is changed, according to one or more embodiments.

FIGS. 6A, 6B, and 6C illustrate examples of an operation in which an electronic apparatus generates an index when information is added to a document file, according to one or more embodiments.

FIG. 7 illustrates an example of an operation in which an electronic apparatus provides a response to a user request, according to one or more embodiments.

FIG. 8 illustrates an example of a configuration of an electronic apparatus, according to one or more embodiments.

FIG. 9 illustrates an example of an operating method (or an indexing method) of an electronic apparatus, according to one or more embodiments.

FIG. 10 illustrates an example of an operating method (or an indexing method) of an electronic apparatus, according to one or more embodiments.

Throughout the drawings and the detailed description, unless otherwise described or provided, it may be understood that the same drawing reference numerals refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

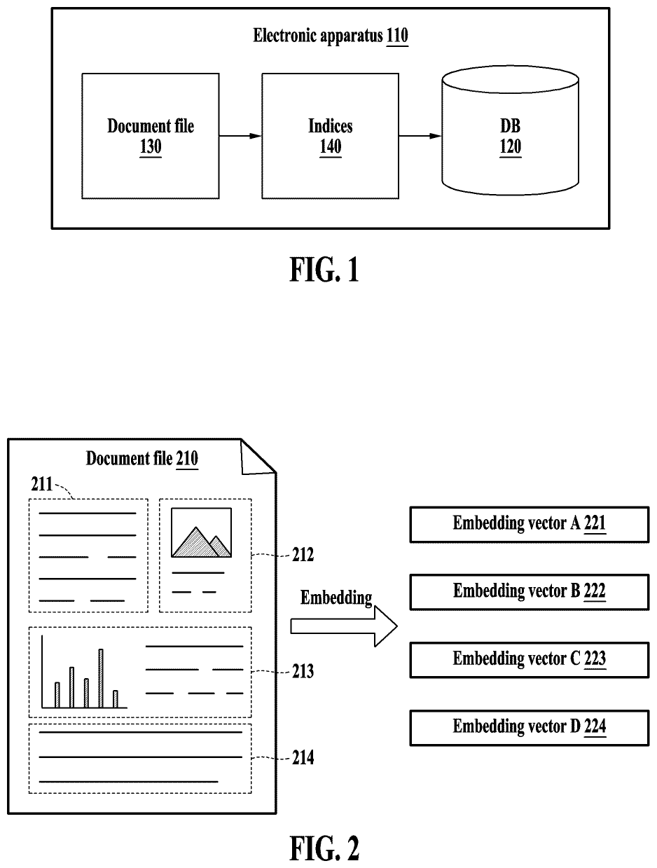

FIG. 1 illustrates an example of an operation of an electronic apparatus for generating an index from a document file, according to one or more embodiments.

Referring to FIG. 1, an electronic apparatus 110 may include a database (DB) 120.

The electronic apparatus 110 may be any of various types of computing devices such as a high performance computer (HPC), a server computer, a desktop, or a workstation.

The electronic apparatus 110 may receive a document file 130. The document file 130 may include text or may be a multi-modal document file including data types such as a first type (e.g., text), a second type (e.g., image), a third type (e.g., table), and/or a fourth type (e.g., graph), for example.

The electronic apparatus 110 may perform chunking on the document file 130 based on a layout. Chunking may involve dividing the document file 130 into pieces (or regions). The electronic apparatus 110 may detect (or obtain) the regions (e.g., layout regions) in the document file 130 through layout-based chunking.

The electronic apparatus 110 may perform embedding on each of the pieces (or regions) detected (or obtained) by performing chunking on the document file 130 to generate embedding vectors for the respective document pieces. The embedding vectors of the respective detected layout regions may be obtained by performing embedding on each of the layout regions detected in the document file 130. Embedding may involve converting a given input (e.g., text, image, etc.) into a number (e.g., vector). The embedding vector corresponding to a detected layout region may represent the detected layout region as a number.

The electronic apparatus 110 may determine (or generate) indices 140 for the document file 130 based on the generated embedding vectors. Specifically, each of the indices 140 may have a corresponding vector that is generated by a different combination of the embedding vectors. However, examples are not limited thereto. Some of the indices 140 may correspond to vectors generated by from respective unique combinations of the embedding vectors, and other of the indices 140 remainder may respectively correspond to the individual embedding vectors.

The electronic apparatus 110 may store the indices 140 in the DB 120. The DB 120 may be a vector DB or a vector store, for example, but examples are not limited thereto.

An existing indexing method may perform semantic chunking (e.g., a scheme of dividing a document file based on semantic similarity) on a document file (or a structured document file) that only includes text (here, semantic similarity may refer to similarity between semantically similar sentences within the document, for example). However, the existing indexing method may not identify the relationship between a non-text object (e.g., an image, a graph, or a table) and text within a multi-modal document file (or a document file including one or more data types in addition to text), and thus may not perform sensible or accurate semantic chunking on the multi-modal document file. The electronic apparatus 110 may divide the document file 130 into a plurality of regions (e.g., layout regions) by performing layout detection on the document file 130 (e.g., a multi-modal document file). The electronic apparatus 110 may generating embedding vectors by performing embedding on each region and may generate an index by combining some of the embedding vectors. Accordingly, the electronic apparatus 110 may generate an index (e.g., a multi-modal index) with the association between a non-text object and text in the document file 130 considered.

FIG. 2 illustrates an example of chunking and embedding of an electronic apparatus, according to one or more embodiments.

FIG. 2 illustrates a document file 210. The document file 210 may include text, a graph, and an image. The document file 210 may be a multi-modal document file.

The electronic apparatus 110 may detect layout regions 211-214 in the document file 210. For example, the electronic apparatus 110 may detect the layout regions 211-214 in the document file 210 using a model that performs layout detection.

In the example illustrated in FIG. 2, layout region 211 may include, for example, a text description of a component A, and layout region 212 may include an image of the component A with a defect and a description of the image. Layout region 213 may include a graph of the defect rate of the component A and a text description of the graph, and layout region 214 may include text about a measure to resolve the defect of the component A.

The electronic apparatus 110 may generate embedding vectors 221-224 respectively corresponding to the layout regions 211-214 by performing embedding on the layout regions 211-214. Embedding vector A 221 may be generated as corresponding to the layout region 211 by performing embedding on the layout region 211 through an embedding model. The embedding vector A 221 may represent the text within the layout region 211 as a number (e.g., a real number). Embedding vector B 222 corresponding to the layout region 212 may be generated through the embedding model. Embedding vector B 222 may represent the image and text within the layout region 212 as numbers. Embedding vector C 223 corresponding to the layout region 213 may be generated through the embedding model. Embedding vector C 223 may represent the graph and text within the layout region 213 as numbers. Embedding vector D 224 corresponding to the layout region 214 may be generated through the embedding model. Embedding vector D 224 may represent the text within the layout region 214 as a number.

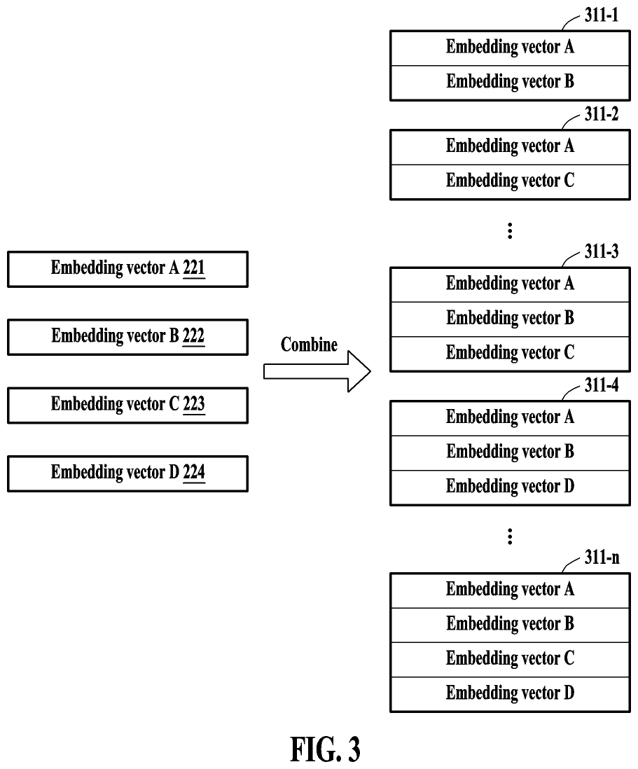

FIG. 3 illustrates an example of a combination of embedding vectors of an electronic apparatus, according to one or more embodiments.

Referring to FIG. 3, the electronic apparatus 110 may determine (or generate) a indices 311-1 to 311-n based on the embedding vectors 221-224.

The electronic apparatus 110 may select some of the embedding vectors 221-224, combine the selected embedding vectors, and generate an index based on the combined selected embedding vectors.

In the example in FIG. 3, embedding vector A 221 and embedding vector B 222 may be selected from among the embedding vectors 221-224 and may generate index 311-1 by combining embedding vector A 221 with embedding vector B 222. Embedding vector A 221 and embedding vector B 222 may correspond to layout region 211 and layout region 212, respectively. Index 311-1 may be an index for a first portion of the document file 210. For example, the first portion may be the layout regions 211 and 212 respectively corresponding to embedding vectors 221 and 222.

Embedding vector A 221 and embedding vector C 223 and may be selected to generate index 311-2 by combining embedding vector A 221 with embedding vector C 223. Index 311-2 may be an index for a second portion of the document file 210, for example, the second portion may be the layout regions 211 and 213 respectively corresponding to embedding vectors 221 and 223).

Embedding vector A 221 embedding vector B 222, and embedding vector C 223 may be selected and combined to generate index 311-3. Index 311-3 may be an index for a third portion of the document file 210, for example, layout regions 211, 212, and 213 respectively corresponding to embedding vectors 221, 222, and 223.

Embedding vector A 221, embedding vector B 222, and embedding vector D 224 and may selected and combined to generate index 311-4. Index 311-4 may be an index for a fourth portion of the document file 210, for example, layout regions 211, 212, and 214 respectively corresponding to embedding vectors 221, 222, and 224.

Embedding vector A 221, embedding vector B 222, embedding vector C 223, and embedding vector D 224 may be selected and combined to generate index 311-n. Index 311-n may be an index for the entire region of the document file 210, for example layout regions 211-214 respectively corresponding to embedding vectors 221-224.

Each of the indices 311-1 to 311-n may correspond to a vector generated by concatenating (or combining) a respective different combination of embedding vectors.

The electronic apparatus 110 may generate vector sets from the embedding vectors 221-224. In this case, each of the vector sets may include one or more embedding vectors. Vector set #1 may be generated by selecting embedding vector A 221 and the embedding vector B 222, and vector set #2 may be generated by selecting embedding vector A 221 and embedding vector C 223. Vector set #3 may be generated by selecting embedding vector A 221, embedding vector B 222, and embedding vector C 223. Vector set #4 may be generated by selecting embedding vector A 221, embedding vector B 222, and embedding vector D 224. Vector set #n may be generated by selecting embedding vector A 221, embedding vector B 222, embedding vector C 223, and embedding vector D 224.

The electronic apparatus 110 may generate each of the indices 311-1 to 311-n by combining embedding vectors within each of the generated vector sets. For example, index 311-1 may be generated by combining the embedding vector A 221 with the embedding vector B 222 in vector set #1. Index 311-2 may be generated by combining embedding vector A 221 with embedding vector C 223 in vector set #2. Index 311-3 may be generated by combining embedding vector A 221, embedding vector B 222, and embedding vector C 223 in vector set #3. Index 311-4 may be generated by combining embedding vector A 221, embedding vector B 222, and embedding vector D 224 in vector set #4. Index 311-n may be generated by combining embedding vector A 221, embedding vector B 222, embedding vector C 223, and embedding vector D 224 in vector set #n.

The electronic apparatus 110 may store the indices 311-1 to 311-n in the DB 120.

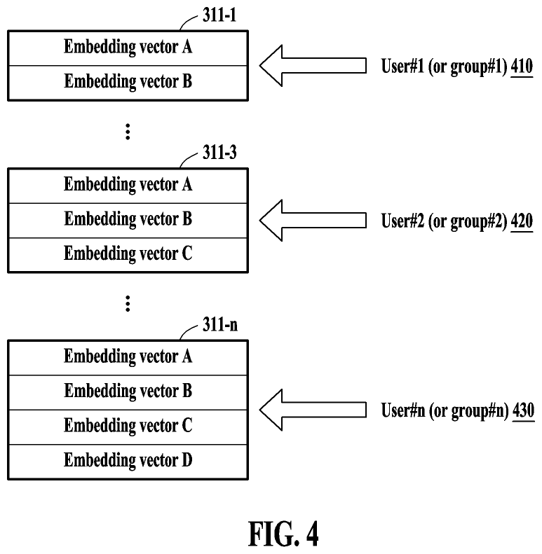

FIG. 4 illustrates an example of an operation in which an electronic apparatus sets permission for each generated index, according to one or more embodiments.

Referring to FIG. 4, the electronic apparatus 110 may set or grant permission (e.g., usage permission or access permission) for an index to a user (or group) so that the user (or group) may access information in a region of the document file 210. For example, permissions may be implemented by access control lists of the respective indices 311-1 to 311-n.

For example, in the example illustrated in FIG. 4, the electronic apparatus 110 may set or grant permission for index 311-1 to user #1 (or group #1) 410. Index 311-1 includes embedding vector A 221 and embedding vector B 222, so user #1 (or group #1) 410 may access information in layout region 211 corresponding to embedding vector A 221 and information in layout region 212 corresponding to embedding vector B 222 but may not access information in layout region 213 corresponding to embedding vector C 223 and information in layout region 214 corresponding to embedding vector D 224. The electronic apparatus 110 may restrict access of user #1 (or group #1) 410 to the information in layout region 213 and the information in layout region 214.

The electronic apparatus 110 may set or grant permission for index 311-3 to user #2 (or group #2) 420. Index 311-3 may include embedding vector A 221, embedding vector B 222, and embedding vector C 223. User #2 (or group #2) 420 may not access the information in layout region 214 corresponding to embedding vector D 224 that is not included in index 311-3. The electronic apparatus 110 may restrict access of user #2 (or group #2) 420 to the information in layout region 214.

The electronic apparatus 110 may set or grant permission for index 311-n to user #n (or group #n) 430. Index 311-n includes embedding vectors 221-224, so user #n (or group #n) 430 may access all information in the document file 210.

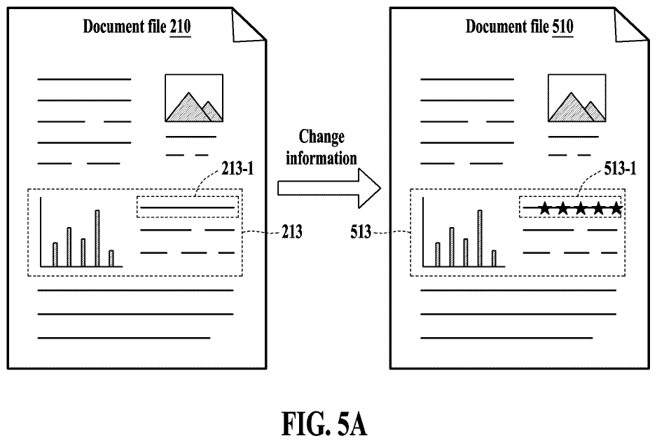

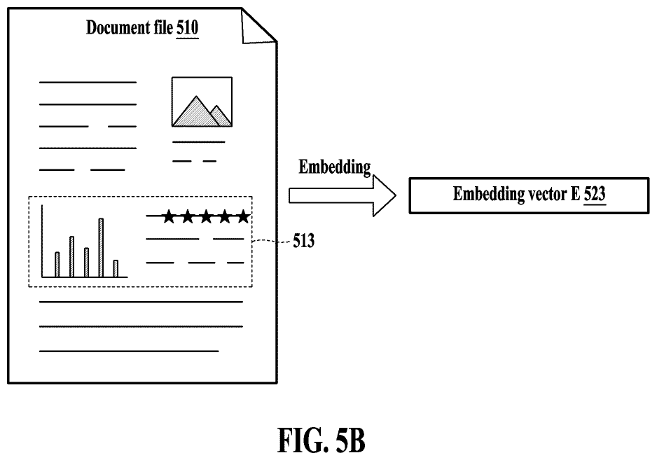

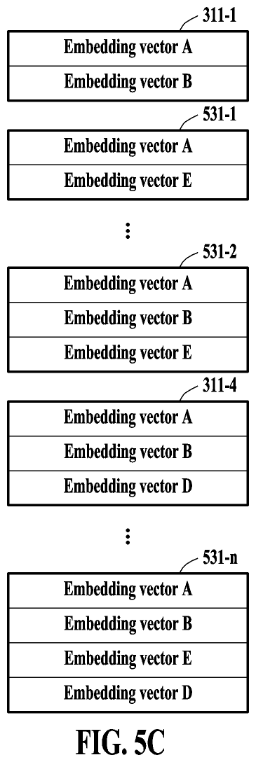

FIGS. 5A, 5B, and 5C illustrate examples of an operation in which an electronic apparatus generates an index when information in a document file is changed, according to one or more embodiments.

Referring to FIG. 5A, first information 213-1 in the document file 210 may be changed to second information 513-1. A document file 510 may be a version of the document file 210 in which the first information 213-1 has been changed to the second information 513-1.

In the example illustrated in FIG. 5B, the electronic apparatus 110 may identify a layout region 513 including the second information 513-1 (i.e., changed information) in the document file 510.

The electronic apparatus 110 may generate embedding vector E 523 corresponding to the layout region 513 (identified based containing a change) by performing embedding on the layout region 513.

Regarding the identifying of the new/changed region 513, the electronic apparatus 110 may recognize that the layout region 213 has changed to the layout region 513 when the first information 213-1 has changed to the second information 513-1. An index including the embedding vector C 223 may be identified as corresponding the layout region (i.e., corresponding to layout region 213) before the change. An index including embedding vector C 223 may be identified as corresponding to the layout region 213 including the first information 213-1 (i.e., pre-change information). FIG. 3 illustrates the indices of the document file 210 identified as including the embedding vector C 223, namely, index 311-2, index 311-3, and index 311-n.

When identifying an index including the embedding vector C 223, the electronic apparatus 110 may combine another embedding vector in the identified index with a newly generated embedding vector (i.e., the embedding vector E 523) of the identified layout region 513 including the second information 513-1 (i.e., changed information). That is, each of the indices identified as affected by the change may be recomputed with combinations of embedding vectors where embedding vector E 523 replaces embedding vector C 223. For example, the electronic apparatus 110 may combine embedding vector A 221 in index 311-2 with embedding vector E 523. Accordingly, index 531-1 may be generated from a combination of embedding vector A 221 with embedding vector E 523, as in the example illustrated in FIG. 5C. Index 531-2 may be generated by combining embedding vector A 221 and embedding vector B 222 (in the index 311-3) with embedding vector E 523. Index 531-n may be generated by combining embedding vector A 221, embedding vector B 222, and embedding vector D 224 (in the index 311-n) with embedding vector E 523. In other words, the indices that include the updated information may be generated as originally generated, but with embedding vector C 223 replaced by the embedding vector for the changed region, in this example, embedding vector E 523.

In the example illustrated in FIG. 5C, the electronic apparatus 110 may maintain index 311-1 and index 311-4 because they are not related to changes in the information of the document file 210 (the content that they index has not changed). The electronic apparatus 110 may generate index 531-1, index 531-2, and index 531-n, as described above, because index 311-2, index 311-3, and index 311-n are related to changes in the information of the document file 210. When generating index 531-1, index 531-2, and index 531-n, the electronic apparatus 110 may replace index 311-2 with index 531-1, replace index 311-3 with index 531-2, and replace index 311-n with index 531-n in the DB 120 (thus deleting index 311-2, index 311-3, and index 311-n). Depending on the implementation, the electronic apparatus 110 may not delete the index 311-2, the index 311-3, and the index 311-n.

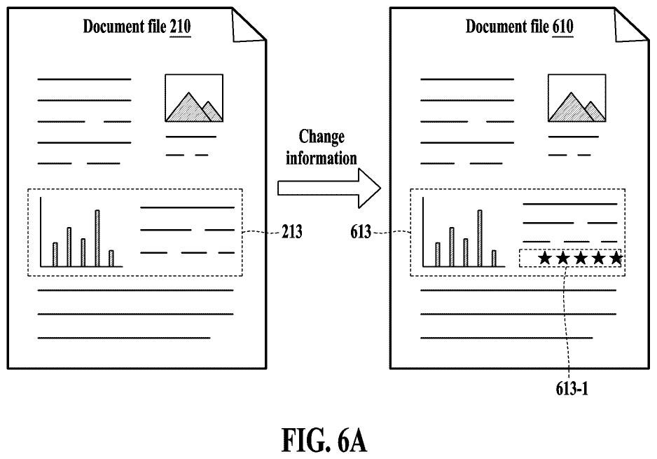

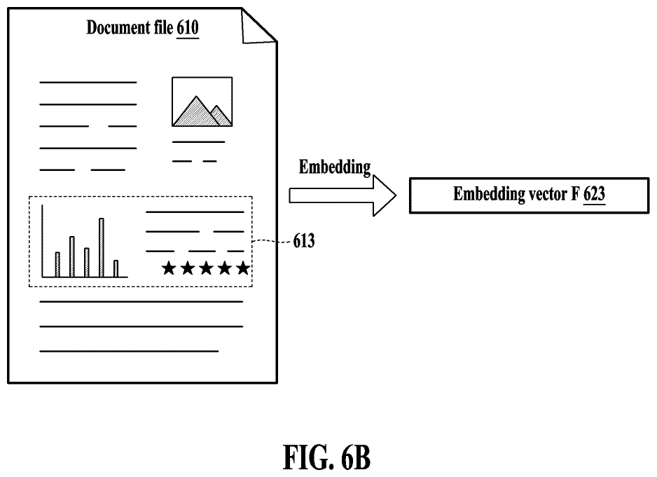

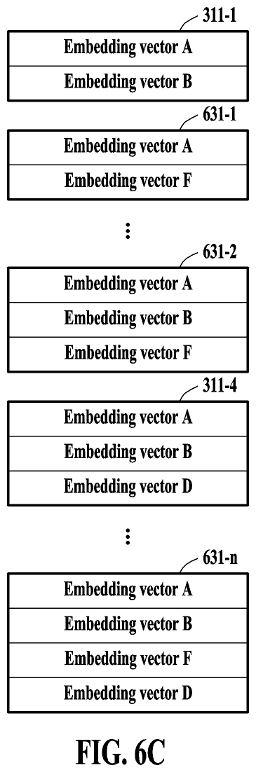

FIGS. 6A, 6B, and 6C illustrate examples of an operation in which an electronic apparatus generates an index when information is added to a document file, according to one or more embodiments.

Referring to FIG. 6A, compared to the document file 210, a version thereof, document file 610, may have had third information 613-1 added thereto. The document file 610 may be a version of the document file 210 with the third information 613-1 added thereto.

In the example illustrated in FIG. 6B, the electronic apparatus 110 may identify a layout region 613 as including the new third information 613-1 (i.e., added information) in the document file 610.

The electronic apparatus 110 may generate an embedding vector F 623 corresponding to the identified layout region 613 by performing embedding on the layout region 613.

The electronic apparatus 110 may recognize that the addition of the third information 613-3 to the document file 610 indicates that the layout region 213 has changed to the layout region 613. An index including the embedding vector C 223 may be identified as corresponding to a layout region (i.e., layout region 213) before the change. Referring to FIG. 3, which illustrates the indices of the document file 210, index 311-2, index 311-3, and index 311-n may include embedding vector C 223.

When identifying whichever index includes embedding vector C 223, the electronic apparatus 110 may combine whichever embedding vectors are in the identified index with the embedding vector (i.e., embedding vector F 623) of the layout region 613 including the third information 613-1 (i.e., added information) supplanting embedding vector C 223. For example, the electronic apparatus 110 may generate index 631-1 of FIG. 6C by combining embedding vector A 221 (in index 311-2) with embedding vector F 623, by combining embedding vector A 221 and embedding vector B 222 (in index 311-3) with embedding vector F 623, and by combining embedding vector A 221, embedding vector B 222, and embedding vector D 224 (in the index 311-n) with embedding vector F 623. To summarize, the indices built from the embedding vector of the updated region may be rebuilt with new embedding vector for the updated region.

In the example illustrated in FIG. 6C, the electronic apparatus 110 may maintain index 311-1 and index 311-4 because they are not related to adding information to the document file 210. The electronic apparatus 110 may generate index 631-1, index 631-2, and index 631-n, as described above, because they are related to adding information to the document file 210. When generating index 631-1, index 631-2, and index 631-n, the electronic apparatus 110 may replace index 311-2 with index 631-1, replace index 311-3 with index 631-2, and replace index 311-n with index 631-n in the DB 120.

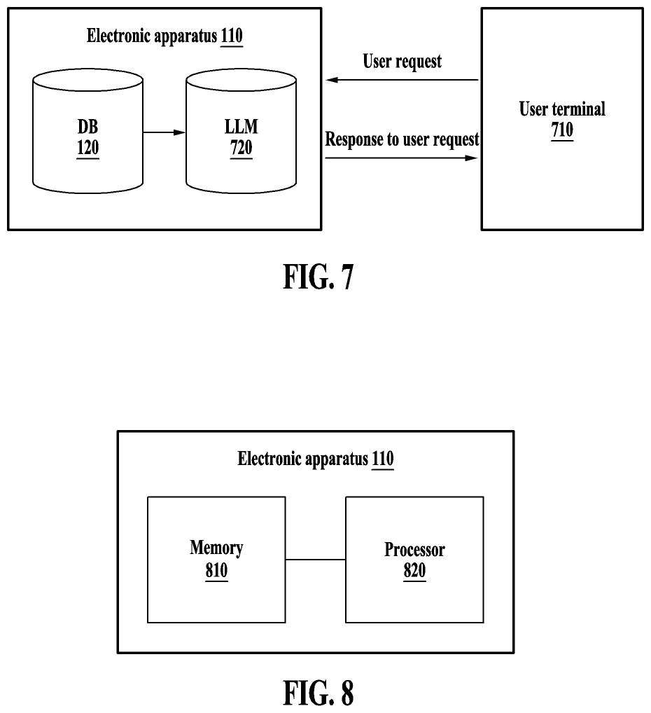

FIG. 7 illustrates an example of an operation in which an electronic apparatus provides a response to a user request, according to one or more embodiments.

Referring to FIG. 7, the electronic apparatus 110 may include the DB 120 and a large language model (LLM) 720 (or similar suitable neural network). The DB 120 may, depending on the times of the previously described updates to the document file 210, store the indices 311-1 to 311-n of the document file 210 of FIG. 6, the indices 311-1, 531-1, 531-2, 311-4, and 531-n of FIG. 5C, or the indices 311-1, 631-1, 631-2, 311-4, and 631-n of FIG. 6C, as the case may be.

A user terminal 710 accessing the electronic apparatus 110 may be a smartphone, a tablet, a laptop, a personal computer (PC), or the like.

The user terminal 710 may transmit a user request (e.g., a prompt and/or a natural language query) to the electronic apparatus 110. The user request may include, for example, natural language text, an image, a video, an audio, or any combination thereof.

The electronic apparatus 110 may generate a response to the user request using the DB 120 and the LLM 720. Through retrieval augmented generation (RAG) technology (e.g., technology using techniques described herein), the electronic apparatus 110 may generate a response to the user request using a sentence generated by the LLM 720 and using an index obtained from the DB 120. The electronic apparatus 110 may obtain (or retrieve), using a retriever (search engine), from the DB 120, an index that matches the user request using (or an index most closely related to the user request). The electronic apparatus 110 may generate a response to the user request using the obtained (or retrieved) index and the LLM 720. Accordingly, the electronic apparatus 110 may avoid inferred hallucination by the LLM 720 (where it provides false information) and may improve answer accuracy.

When obtaining an index from the DB 120 based on the user request, the electronic apparatus 110 may determine whether the requesting user has permission for the obtained index. When the user has the permission for the obtained index, the electronic apparatus 110 may generate a response to the user request based on the obtained index and transmit the generated response to the user terminal 710. When the user does not have the permission for the obtained index, the electronic apparatus 110 may transmit, to the user terminal 710, a response indicating that access to information corresponding to the user request is not possible. Alternatively, the user's search may be completed without using index information not permitted for the user.

For example, the electronic apparatus 110 may receive, from a user terminal of user #1 410 of FIG. 4, a user request #1 (e.g., a request for a description of the component A described with reference to FIG. 2 and a request for an image of the component A with a defect). The electronic apparatus 110 may obtain, from the DB 120, the index 311-1 most closely related to the received user request #1. In an example, The electronic apparatus 110 may determine a vector corresponding to the received user request #1. The electronic apparatus 110 may obtain the index 311-1 when a distance between the vector corresponding to the received user request #1 and the index 311-1 is the smallest or a similarity (e.g. cosine similarity) between the vector corresponding to the received user request #1 and the index 311-1 is the highest. The electronic apparatus 110 may determine that user #1 410 has the permission for the obtained index 311-1, and thus may generate response #1 to user request #1 using the obtained index 311-1 and the LLM 720; the generated response #1 may be transmitted to the user terminal 710.

In another example, the electronic apparatus 110 may receive, from the user terminal of user #1 410 of FIG. 4, user request #2 (e.g., a request for description of the component A, a request for an image of the component A with a defect, a request for a graph for a defect rate of the component A, and a request for a measure to resolve the defect of the component A). The electronic apparatus 110 may obtain, from the DB 120, index 311-n as being the index most closely related to the received user request #2. The electronic apparatus 110 may determine that user #1 410 does not have permission for the obtained index 311-n. In this case, the electronic apparatus 110 may transmit, to the user terminal of user #1, a message indicating failure to provide a response to the user request #2. Since user #1 410 does not have access permission for the graph for the defect rate of the component A and does not have access permission for the measures to resolve the defect of the component A, the electronic apparatus 110 may transmit, to the user terminal of user #1, a message indicating failure to provide a response to the user request #2 (or indicating that the returned information is incomplete).

The electronic apparatus 110 may select information in the document file 210 and provide the selected information to the user, thereby limiting the accessibility of the user and enhancing the security of the document file 210.

FIG. 8 illustrates an example of a configuration of an electronic apparatus, according to one or more embodiments.

Referring to FIG. 8, the electronic apparatus 110 may include memory 810 and a processor 820.

The memory 810 may store the DB 120 and/or the LLM 720. Depending on the implementation, the DB 120 may be stored in the memory 810 (or first memory), and the LLM 720 may be stored in another memory (or second memory).

The processor 820 may detect layout regions (e.g., the layout regions 211-214 of FIG. 2) in a document file (e.g., the document file 210 of FIG. 2). The processor 820 may detect the layout regions in the document file by applying a layout detection technique to the document file.

The processor 820 may generate embedding vectors of the respective layout regions by performing embedding on each of the layout regions. For example, the processor 820 may generate the embedding vectors 221-224 of the respective layout regions 211-214.

The processor 820 may combine selected embedding vectors among the generated embedding vectors. The processor 820 may select embedding vectors required for retrieval and combine the selected embedding vectors. For example, the processor 820 may select the embedding vector A 221, the embedding vector B 222, and the embedding vector C 223 and combine the embedding vector A 221, the embedding vector B 222, and the embedding vector C 223.

Based on the result of combining the selected embedding vectors (e.g., the embedding vectors 221, 222, and 223), the processor 820 may determine (or generate) a first index for the layout regions of the selected embedding vectors. The processor 820 may determine, as the first index, a vector generated by concatenating the selected embedding vectors. For example, when selecting the embedding vector A 221, the embedding vector B 222, and the embedding vector C 223, the processor 820 may determine, as index 311-3, a vector generated by combining embedding vector A 221, embedding vector B 222, and embedding vector C 223 for the layout regions 211, 212, and 213 of the embedding vectors 221, 222, and 223.

The processor 820 may store the first index (e.g., index 311-3) in the DB 120.

The processor 820 may set a user or a group that may access the first index. The processor 820 may restrict which users may access the first index.

The processor 820 may receive a user request from the user terminal 710. The processor 820 may determine whether the first index is related to the user request of the user terminal 710. The processor 820 may determine that the first index among the indices stored in the DB 120 is most related to the user request of the user terminal 710. The processor 820 may determine whether the user of the user terminal 710 has permission for the first index. When determining that the user has permission for the first index, the processor 820 may generate a response to the user request based on the first index. The processor 820 may transmit the generated response to the user terminal 710. When determining that the user does not have permission for the first index, the processor 820 may transmit, to the user terminal 710, a message indicating failure to provide a response to the user request.

When information in the document file 210 is changed, the processor 820 may identify a layout region (e.g., the layout region 513 of FIG. 5) including the changed information (e.g., the second information 513-1 of FIG. 5A). The processor 820 may generate a first embedding vector (e.g., the embedding vector E 523 of FIG. 5B) of the identified layout region 513. When a second embedding vector (e.g., the embedding vector C 223) of the layout region 213 including pre-change information (e.g., the first information 213-1 of FIG. 5A) is included in the first index, the processor 820 may combine the first embedding vector with other embedding vectors (e.g., the embedding vector A 221 and the embedding vector B 222) in the first index. Based on the result of combining the first embedding vector with other embedding vectors in the first index, the processor 820 may determine (or generate) a second index (e.g., the index 531-2 of FIG. 5C). The second index (e.g., the index 531-2 of FIG. 5C) may be an index for the identified layout region 513, layout region 211, and layout region 212.

The processor 820 may replace the first index with the second index in the DB 120.

The description provided with reference to FIGS. 1 to 7 is generally applicable to the electronic apparatus 110 of FIG. 8.

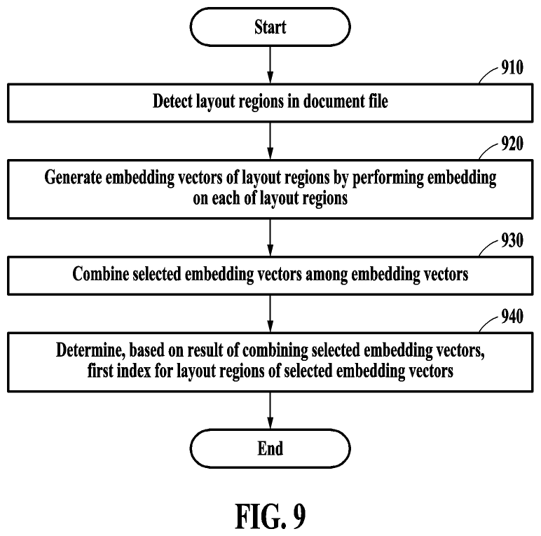

FIG. 9 illustrates an example of an operating method (or an indexing method) of an electronic apparatus, according to one or more embodiments.

Referring to FIG. 9, in operation 910, the electronic apparatus 110 may detect layout regions in a document file.

In operation 920, the electronic apparatus 110 may generate embedding vectors of the respective layout regions by performing embedding on each of the layout regions.

In operation 930, the electronic apparatus 110 may combine selected embedding vectors among the embedding vectors.

In operation 940, the electronic apparatus 110 may determine, based on the result of combining the selected embedding vectors, a first index for layout regions of the selected embedding vectors.

The electronic apparatus 110 may determine the first index and then store the first index in the DB 120.

The electronic apparatus 110 may receive a user request from the user terminal 710 and obtain the first index by performing retrieval on the DB 120 based on the received user request. The electronic apparatus 110 may generate a response to the user request using a generative model (e.g., the LLM 720 of FIG. 7) and the obtained first index. The electronic apparatus 110 may transmit the generated response to the user terminal 710.

The description provided with reference to FIGS. 1 to 8 is generally applicable to the operating method of the electronic apparatus 110 of FIG. 9.

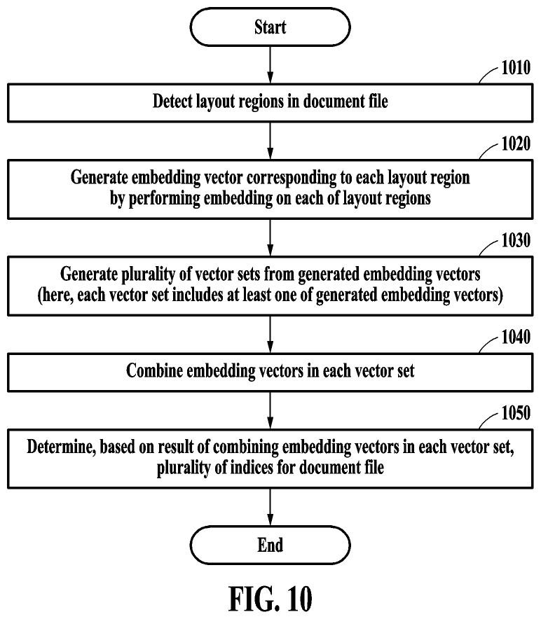

FIG. 10 illustrates an example of an operating method (or an indexing method) of an electronic apparatus, according to one or more embodiments.

Referring to FIG. 10, in operation 1010, the electronic apparatus 110 may detect layout regions in a document file.

In operation 1020, the electronic apparatus 110 may generate an embedding vector corresponding to each of the layout regions by performing embedding on each of the layout regions.

In operation 1030, the electronic apparatus 110 may generate a plurality of vector sets (e.g., the vector set #1 to the vector set #n described with reference to FIG. 3) from the generated embedding vectors. Here, each vector set may include at least one of the generated embedding vectors.

In operation 1040, the electronic apparatus 110 may combine the embedding vectors in each of the generated vector sets.

In operation 1050, the electronic apparatus 110 may determine (or generate) a indices (e.g., the indices 311-1 to 311-n described with reference to FIG. 3) for the document file based on the result of combining the embedding vectors in each of the generated vector sets. The electronic apparatus 110 may determine, as each index, each vector generated by concatenating the embedding vectors in each of the generated vector sets.

The electronic apparatus 110 may store the determined indices in the DB 120.

The electronic apparatus 110 may obtain a first index by performing retrieval on the DB 120 based on a user request received from a user terminal. The electronic apparatus 110 may generate a response to the user request using a generative model (e.g., the LLM 720 of FIG. 7) and the obtained first index. The electronic apparatus 110 may transmit the generated response to the user terminal.

The electronic apparatus 110 may set a user or a group that may access each of the determined indices.

The electronic apparatus 110 may obtain, from the DB 120, an index (e.g., an index most similar to the received user request) related to the received user request. The electronic apparatus 110 may determine whether the user has permission for the obtained index (e.g., the first index). When determining that the user has permission for the obtained index, the electronic apparatus 110 may generate a response to the user request using the obtained index and the generative model. The electronic apparatus 110 may transmit the generated response to the user terminal.

When information in the document file is changed, the electronic apparatus 110 may identify a layout region including the changed information. The electronic apparatus 110 may generate a first embedding vector corresponding to the identified layout region. The electronic apparatus 110 may identify an index including an embedding vector corresponding to a layout region including pre-change information among indices for the document file. The electronic apparatus 110 may combine the first embedding vector with other embedding vectors in the identified index. The electronic apparatus 110 may determine (or generate), based on the result of combining other embedding vectors with the first embedding vector, an index to replace the identified index.

The electronic apparatus 110 may semantically select a desired region from the document file and generate an index. The electronic apparatus 110 may shorten the retrieval time by reducing the total amount of indices to be retrieved. The electronic apparatus 110 may quickly generate multiple indices because combining embedding vectors and generating a new index take a short amount of time. The electronic apparatus 110 may limit user accessibility by index, thereby improving the security of a document file. When the content of a document file is changed, the electronic apparatus 110 may conveniently maintain and/or repair the document file by generating a new embedding vector corresponding to the region of the changed content and then generating a new index.

The description provided with reference to FIGS. 1 to 9 is generally applicable to the operating method of the electronic apparatus 110 of FIG. 10.

The computing apparatuses, the electronic devices, the processors, the memories, the displays, the information output system and hardware, the storage devices, and other apparatuses, devices, units, modules, and components described herein with respect to FIGS. 1-10 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operating method of an electronic apparatus, the operating method comprising:
detecting layout regions in a document file;
generating embedding vectors of the respective detected layout regions by performing embedding operations on the respective detected layout regions;
forming a combination of embedding vectors selected from among the generated embedding vectors;
determining, based on the combination of the selected embedding vectors, a first index indexing the layout regions respectively corresponding to the selected embedding vectors;
accessing the first index based on a received user request; and
generating a response to the received user request using a generative model and the accessed first index.

2. The operating method of claim 1, wherein the combination of the selected embedding vectors comprises a vector generated by concatenating the selected embedding vectors.

3. The operating method of claim 1, further comprising:
receiving the user request from a user terminal;
in response to obtaining, from a database (DB), the first index related to the received user request, determining whether a user has permission for the first index;
in response to determining that the user has the permission, generating the response using the first index and the generative model; and
transmitting the generated response to the user terminal.

4. The operating method of claim 1, further comprising:
receiving the user request from a user terminal;
in response to obtaining, from a database (DB), the first index related to the received user request, determining whether a user has permission for the first index;
in response to determining that the user does not have the permission, transmitting, to the user terminal, a message indicating failure to provide the response to the user request.

5. The operating method of claim 1, further comprising:
based on content in the document file being changed, identifying a layout region, among the detected layout regions, encompassing the changed information;
generating a first embedding vector of the identified layout region, the first embedding vector reflecting the changed content;
based on the first index comprising a second embedding vector of a layout region encompassing the content before being changed, forming a combination of an embedding vector in the first index other than the second embedding vector and the generated first embedding vector; and
determining, based on the combination of the generated first embedding vector with the other embedding vector in the first index, a second index for the identified layout region and a layout region of the embedding vector in the first index.

6. The operating method of claim 5, further comprising:
replacing the first index with the determined second index in a database (DB).

7. The operating method of claim 1, further comprising:
setting a user or a group with access to the first index.

8. An operating method of an electronic apparatus, the operating method comprising:
generating embedding vectors respectively corresponding to each of layout regions of a document file by performing embedding operations on the respective layout regions;
generating vector sets from the generated embedding vectors, wherein each of the vector sets comprises at least one of the generated embedding vectors;
forming combinations of embedding vectors from the respective generated vector sets;
determining indices for the document file from the respective combinations;
storing the indices in a database (DB);
accessing, from the DB, based on a received user request, a first index among the indices stored in the DB; and
generating a response to the received user request using a generative model and the accessed first index.

9. The operating method of claim 8, wherein each index is a concatenation of the embedding vectors in its corresponding vector set.

10. The operating method of claim 8, further comprising:
receiving the user request from a user terminal;
in response to accessing, from the DB, the first index related to the received user request, determining whether a user has permission for the first index;
in response to determining that the user has the permission, generating the response using the first index and the generative model; and
transmitting the generated response to the user terminal.

11. The operating method of claim 8, further comprising:
receiving the user request from a user terminal;
in response to accessing, from the DB, the first index related to the received user request, determining whether a user has permission for the first index;
in response to determining that the user does not have the permission, transmitting, to the user terminal, a message indicating failure to provide a response to the user request.

12. The operating method of claim 8, further comprising:
in response to information in the document file being changed, identifying a layout region encompassing the changed information;
generating a first embedding vector from the changed information in the identified layout region;
identifying, among the indices, an index corresponding to the identified layout region, the index of the identified layout region comprising one of the generated embedding vectors;
generating a replacement index comprising a combination of the one of the generated embedding vectors and the generated first embedding vector; and
in the DB, replacing the identified index with the generated first index.

13. The operating method of claim 8, further comprising:
setting a user or a group with access to each of the determined plurality of indices.

14. An electronic apparatus comprising:
one or more processors; and
memory storing instructions configured to cause the one or more processors to:
detect layout regions in a document file;
based on the detected layout regions, generate embedding vectors of the respective detected layout regions by performing embedding on portions of content in the respective detected layout regions;
form a combination of at least some of the embedding vectors;
generate a first index indexing those of the layout regions that respectively correspond to the at least some of the embedding vectors;
access the first index based on a received user request; and
generate a response to the received user request using a generative model and the accessed first index.

15. The electronic apparatus of claim 14, wherein the first index includes the combination, which is a concatenation of the at least some of the embedding vectors.

16. The electronic apparatus of claim 14, wherein the instructions are further configured to cause the one or more processors to:
receive the user request from a user terminal;
in accessing the first index from a database (DB) to service the received user request, determine whether a user has permission specific to the first index;
in response to determining that the user has the permission specific to the first index, generate the response using the first index and the generative model; and
transmit the generated response to the user terminal.

17. The electronic apparatus of claim 14, wherein the instructions are further configured to cause the one or more processors to:
receive the user request from a user terminal;
in accessing the first index from a database (DB) to service the received user request, determine whether a user has permission specific to the first index; and
in response to determining that the user does not have the permission specific to the first index, transmit, to the user terminal, a message indicating failure to provide the response to the user request.

18. The electronic apparatus of claim 14, wherein the instructions are further configured to cause the one or more processors to:
identify a content change within a layout region among the layout regions;
generate a first embedding vector for the changed layout region, the first embedding vector reflecting the content change;
determine that the first index corresponds to the layout region identified as having changed;
select a second embedding vector of the identified first index, the second embedding vector not corresponding to a layout region other than the changed layout region; and
form a second index from a combination of the first embedding vector and the second embedding vector.

19. The electronic apparatus of claim 18, wherein the instructions are further configured to cause the one or more processors to replace the first index with the second index in a database (DB).

20. The electronic apparatus of claim 14, wherein the instructions are further configured to cause the one or more processors to set a user or a group with access to the first index.
